(19) United States
(12) Patent Application Publication
(10) Pub. No.: US 2008/0000444 A1
(43) Pub. Date: Jan. 3, 2008

(54) Piston for an Internal Combustion Engine, Method for Producing Said Piston and Use of a Copper Alloy in the Production of a Piston

(75) Inventors: Lothar Hofmann, Neumarkt (DE); Klaus Lades, Nurnberg (DE); Karl-Heinz Obermeier, Burgbernheim (DE)

Correspondence Address: Christopher C Dunham;COOPER & DUNHAM, 1185 Avenue of the Americas, New York, NY, 10036, US

(73) Assignee: FEDERAL-MOGUL NUERNBERG GMBH, Nuernberg (DE)

(21) Appl. No.: 10/592,856

(22) PCT Filed: Mar. 9, 2005
(86) PCT No.: PCT/EP05/02497

§ 371 Date: Nov. 30, 2006

(30) Foreign Application Priority Data
Mar. 17, 2004 (DE) 10 2004 013 181.3

(51) Int. Cl. F02F 3/00

(52) U.S. Cl. 123/193.6

(57) ABSTRACT

The invention relates to a piston for an internal combustion engine, which consists of a copper alloy. According to the method for producing such a piston, said piston is produced from a copper alloy. According to the invention, a copper alloy is used in the production of a piston for an internal combustion engine.

### FIELD OF THE INVENTION

The invention relates to a piston for an internal combustion engine, a method for producing said piston and the use of a copper alloy in the production of such a piston.

There is a tendency in the field of internal combustion engines to continuously increase the specific output. This means that, for example, the occurring ignition pressures as well as the temperatures increase. Cases are being encountered more and more frequently, in particular in diesel engines and modern, highly supercharged spark ignition engines, in which pistons made from the traditional piston material aluminium can no longer cope with the prevailing loads in connection with stress and temperature.

### PRIOR ART

It is being increasingly observed in the field of diesel pistons that steel is being used as the piston material instead of aluminium. However, this leads to various disadvantages. For example, steel pistons are heavier and have poorer heat conductivity than aluminium pistons. The poor heat conductivity leads, for example, to the pistons having to be provided with a cooling duct. This leads to higher manufacturing costs owing to more complex production. Furthermore, a comparatively high piston temperature occurs in a steel piston in spite of an integrated cooling duct. This is in particular clearly higher than in comparable aluminium pistons. This disadvantageously leads to the proportion of nitrogen oxides in the exhaust gas being higher. Furthermore, a comparatively hot piston reduces the “filling level” of the combustion chamber with air, which leads to a reduction in performance. This has to be compensated for by means of expensive engine-related measures such as, for example, a higher charging pressure and a charge-air cooler in the case of turbo engines. Steel pistons furthermore normally have to be forged in complex processes. Owing to the high wear of the forging tools, the service life of the forging tools is short and the production costs for steel pistons are accordingly high in this regard.

Known from EP 0 712 340 B1 is a casting process for producing a piston, in which a first workpiece made of an alloy with an iron or copper base is cast around with an alloy having an aluminium base.

According to DE 31 44 123 A1, a light alloy piston comprises a combustion chamber cavity having a reinforcement consisting of an insert made of a copper alloy.

U.S. Pat. No. 2,241,815 describes a copper alloy casting which is described as being suitable for structural parts in the electrical and mechanical fields.

EP 1 158 062 B1 discloses the use of a wrought copper-zinc-aluminium material for the manufacture of bearing bushes, for example for pistons of internal combustion engines.

DE 44 15 629 C1 relates to the use of a copper-nickel-silicon alloy for the production of casting pistons for die casting machines.

Known from DE 430 188 C is a piston for internal combustion engines, which consists of a steel or iron jacket and a brazed bottom of a copper alloy, the bottom being drawn up to the vicinity of the piston-pin boss.

DE 44 14 095 A1 discloses a method for the production of a composite part, for example a piston, in which a ring carrier and, in certain embodiments, parts of the surface of the piston head can consist of a cast-in part made of a copper alloy.

Known from DE 597 938 C is the use of copper alloys for piston rings.

Finally, U.S. Pat. No. 1,700,604 discloses a piston in which the piston head is made of a copper alloy.

### DESCRIPTION OF THE INVENTION

The object of the invention is to create a piston for an internal combustion engine, which has been improved in respect of its properties and economic producibility, a method for producing said piston and a novel use of a copper alloy.

This object is solved, on the one hand, by the piston described in claim 1.

Accordingly, a piston for an internal combustion engine is made in a novel manner from a copper alloy. Within the following meaning, the piston is made, in particular, exclusively of a copper alloy. Contrary to that known from the prior art as described above, the piston does not comprise individual parts that are subsequently cast around or used with another alloy. The basic body of the piston is rather, as mentioned above, made entirely from a copper alloy. As will be explained in more detail below, the piston can be coated and thus with the exception of an optional coating, it is consequently made entirely of a copper alloy.

The selection of this material for a piston of an internal combustion engine leads to the following advantages. Copper alloys have a much higher heat conductivity as compared, for example, to steels used for engine pistons. The heat produced can therefore be reliably dissipated and there is no need, for example, to provide a cooling duct in the piston. It is thus also possible to dispense with the measures required herefor in a steel piston, which leads to a reduction in production costs. Owing to the fact that the temperature of a piston made of a copper alloy is clearly lower than that of comparable steel pistons, the aforementioned disadvantages of steel pistons in terms of engine technology are eliminated.

Furthermore, copper alloys can clearly be deformed in a simpler and more cost-effective manner than steels which normally have to be forged. In particular, a solution heat-treated copper alloy can be formed, for example, by means of extrusion. Wear of the tool is clearly lower in this case than in the processing of steel pistons. The weight of pistons made from copper alloys is comparable with that of steel pistons. The mechanical strength is also comparable and has proven to comply in particular with those requirements which apply for use as engine pistons. As regards the production of an engine piston, copper alloys furthermore have the advantage that owing to the good deformability of the copper alloys, the wall thicknesses only have to be designed as thickly as is necessary owing to strength requirements. The weight can hereby be reduced in an advantageous manner. The wall thicknesses in steel pistons on the other hand are sometimes greater than required by strength requirements owing to the poor deformability of the steel.

Overall, the invention thus creates a piston of an internal combustion engine which meets the prevailing requirements, is improved in particular as regards temperature, and can furthermore be produced in an economic manner.

Preferred developments of the piston according to the invention are described in the further claims.

An alloy containing nickel and/or silicon has proven, in tests, to be advantageous as the copper alloy to be used. Based on test results, an alloy composition is currently particularly preferred that contains 1% to 7% nickel and/or 0.2% to 5% silicon, with the remainder consisting of copper. Further preferred is 2.5% to 7% nickel and/or more than 1.5% to 5% silicon. Even more preferred is more than 4%, in particular more than 5%, to 7% nickel and/or more than 2% to 5% silicon.

Advantages with regard to high-temperature oxidation can also be achieved if the copper alloy contains up to 5% aluminium. An increase in strength was furthermore observed if the alloy contains at least one of the following elements in the specified amount: up to 4% tin, up to 30% zinc, up to 5% iron and/or up to 5% manganese, up to 1% cobalt, up to 2% chromium.

As mentioned above, the piston can be at least partly coated, which results in advantages in connection with oxidation protection.

Nickel and/or aluminium and/or iron, which can be alloyed, for example, with chromium to make it scale-resistant, have proven beneficial as coating materials.

Even though the piston according to the invention, which is made of a copper alloy, can also have a cooling duct in certain cases of use, it is currently preferred, in view of production costs, for the piston to be formed solidly, in other words without a cooling duct.

The solution to the aforementioned object is furthermore achieved by means of a method for producing a piston for an internal combustion engine, in which the piston is made of a copper alloy. A cost-effective method is hereby provided for producing an engine piston having improved properties in particular with regard to the prevailing temperatures. The production method is extremely economical owing to the aforementioned beneficial properties of the copper alloy, such as, for example, the easy formability, and the possibility of dispensing with a cooling duct.

Preferred developments of the method according to the invention arise on the one hand, for example in view of the alloys to be used, from the preferred measures described above in connection with the piston.

It is furthermore currently preferred to first of all cast the copper alloy used.

Particular advantages arose in tests for a continuous casting (strand casting) method with optional water cooling.

Further processing can take place in an advantageous manner by means of extrusion moulding.

The alloy is then preferably subjected to solution heat treatment at, for example, 750° C. to 950° C., which is beneficial for deformability. Cooling then occurs, preferably a comparatively quick cooling, which is beneficial for avoiding precipitations.

For formation of the actual piston, it is currently preferred to separate sections from the solution heat-treated strand, to heat these and then to form them into a piston. This formation preferably occurs by means of extrusion.

Forging is a conceivable alternative. If this method is used, a subsequent rapid cooling is preferably provided.

Subsequent hardening at, for example, 350° C. to 550° C., for instance, for 0.5 to 10 hours, is currently preferred. This hardening can take place in an inert gas atmosphere in order to improve the result.

It is additionally mentioned that the piston is then machine finished in the normal manner as part of the production method and can, in particular, be coated, as already described above for the piston.

The solution to the object forming the basis for the invention finally arises owing to the use of a copper alloy for the production of a piston for an internal combustion engine. In particular, exclusively a copper alloy is used for the production of the piston. This use leads, in a novel and advantageous manner, to an economically producible piston with improved properties. The copper alloys already described above are again preferred within the scope of the use according to the invention.

### EXAMPLE

As an example according to the invention, a piston was produced from a copper alloy having 1% to 7% nickel, 0.2% to 5% silicon, up to 5% aluminium, up to 4% tin, up to 30% zinc, up to 5% iron and up to 5% manganese. The alloy was cast in a continuous casting (strand casting) method and then extrusion moulded. The alloy was then subjected to solution heat treatment at 750° C. to 950° C. and subsequently rapidly cooled. Precipitations were thereby avoided. Individual sections were separated from this solution heat-treated strand, then heated and each formed into pistons. This deformation took place in a beneficial manner by means of extrusion. The piston blank hereby obtained was hardened for 0.5 to 10 hours at 350° C. to 550° C. and was then finally machine finished. As the tests show, a piston having improved properties, in particular with regard to temperature resistance, was obtained.

1. Piston for an internal combustion engine, said piston consisting of a copper alloy.

2. Piston according to claim 1, characterised in that the copper alloy contains nickel and/or silicon.

3. Piston according to claim 2, characterised in that the copper alloy contains nickel in an amount of 1% to 7% and/or silicon in an amount of 0.2% to 5%, preferably 2.5% to 7% nickel and/or more than 1.5% to 5% silicon, further preferred more than 4%, and even more preferred more than 5%, to 7% nickel and/or more than 2% to 5% silicon.

4. Piston according to claim 1, characterised in that the copper alloy furthermore contains at least one of the following elements in the respectively specified amount: up to 5% aluminium, up to 4% tin, up to 30% zinc, up to 5% iron, up to 5% manganese, up to 1% cobalt, up to 2% chromium.

5. Piston according to claim 1, characterised in that said piston is at least partly coated.

6. Piston according to claim 5, characterised in that said piston is coated with nickel, aluminium and/or iron, preferably alloyed with chromium.

7. Piston according to claim 1, characterised in that said piston does not comprise a cooling duct.

8. Method for the production of a piston for an internal combustion engine, in which said piston is produced from a copper alloy.

9. Method according to claim 8, characterised in that the copper alloy contains nickel and/or silicon.

10. Method according to claim 9, characterised in that the copper alloy contains nickel in an amount of 1% to 7% and/or silicon in an amount of 0.2% to 5%, preferably 2.5% to 7% nickel and/or more than 1.5% to 5% silicon, further preferred more than 4%, and even more preferred more than 5%, to 7% nickel and/or more than 2% to 5% silicon.

11. Method according to claim 8, characterised in that the copper alloy furthermore contains at least one of the following elements in the respectively specified amount: up to 5% aluminium, up to 4% tin, up to 30% zinc, up to 5% iron, up to 5% manganese, up to 1% cobalt, up to 2% chromium.

12. Method according to claim 8, characterised in that the alloy is first of all cast.

13. Method according to claim 12, characterised in that the alloy is cast by means of a continuous casting method, preferably with subsequent water cooling.

14. Method according to claim 8, characterised in that extrusion moulding occurs as part of the method.

15. Method according to claim 8, characterised in that as part of the method, the copper alloy is subjected to solution heat treatment and then rapidly cooled.

16. Method according to claim 8, characterised in that the piston is formed by extrusion.

17. Method according to claim 8, characterised in that the piston is formed by forging.

18. Method according to claim 8, characterised in that as part of the method, a piston blank is hardened preferably in an inert gas atmosphere.

19. Method according to claim 8, characterised in that the piston is at least partly coated.

20. Method according to claim 8, characterised in that the piston is coated with nickel and/or aluminium and/or iron, preferably alloyed with chromium.

21. Use of a copper alloy for the production of a piston for an internal combustion engine.

22. Use according to claim 21, characterised in that the copper alloy contains nickel and/or silicon.

23. Use according to claim 22, characterised in that the copper alloy contains nickel in an amount of 1% to 7% and/or silicon in an amount of 0.2% to 5%, preferably 2.5% to 7% nickel and/or more than 1.5% to 5% silicon, further preferred more than 4%, and even more preferred more than 5%, to 7% nickel and/or more than 2% to 5% silicon.

24. Use according to claim 21, characterised in that the copper alloy furthermore contains at least one of the following elements in the respectively specified amount: up to 5% aluminium, up to 4% tin, up to 30% zinc, up to 5% iron, up to 5% manganese, up to 1% cobalt, up to 2% chromium.
